(19) United States
(12) Patent Application Publication
(10) Pub. No.: US 2006/0155555 A1
(43) Pub. Date: Jul. 13, 2006

(54) Utility computing method and apparatus

(75) Inventors: Eric Lawrence Barsness, Pine Island, MN (US); John Matthew Santosuosso, Rochester, MN (US)

Correspondence Address: Grant A. Johnson;IBM Corporation, Dept. 917, 3605 Highway 52 North, Rochester, MN, 55901-7829, US

(73) Assignee: International Business Machines Corporation, Armonk, NY (US)

(21) Appl. No.: 11/027,725

(22) Filed: Dec. 30, 2004

(51) Int. Cl. G06Q 99/00

(52) U.S. Cl. 705/1

(57) ABSTRACT

A method, system, and computer program product that provide for more uniform pricing of utility computing resources, such as a computing grid. One aspect of the present invention is a method of calculating costs in a utility computing environment comprising receiving a request to process a work unit from a requester, generating at least one performance metric associated with the work unit, and debiting the requestor for processing the work unit based at least in part on the performance metric. The performance metric in this embodiment is related to an amount of resources required to process the work unit under predetermined conditions.

The present invention generally relates to methods for managing networked computer systems. More particularly, the present invention relates to a method, apparatus, and computer program product for providing more uniform pricing of utility computing resources.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are dramatically more powerful than just a few years ago.

Originally, most computer systems were isolated devices that did not communicate with each other. More recently, computer systems were often connected into networks over which a user at one computer, often called a “client,” could access information and resources at multiple other computers, often called “servers.” These networks could be a local network that connects computers associated with the same company, e.g., a Local Area Network (“LAN”), or could be an external network that connects computers from disparate users and companies, such as the Internet or World Wide Web.

Grid computing can be seen as the next step in this evolution. The grid enables the virtualization of distributed computing and data resources, such as processing, network bandwidth and storage capacity. With grid computing, organizations can optimize computing and data resources, pool them for large capacity workloads, share them across networks and enable collaboration. In this way, grid computing offers a means for offering information technology as a utility, like electricity or water, with clients paying only for what they use.

At its core, grid computing is based on an open set of standards and protocols, such as the Globus Toolkit and the Open Grid Services Architecture, that enable communication across heterogeneous, geographically dispersed environments. These standards and protocols are often used in conjunction with logical partitioning (“LPAR”) techniques to create virtual computing devices. In this way, a grid client/user essentially sees a single, large virtual computer that may consist of a portion of a single, powerful computer, a group of several individual computer systems that cooperate to complete a single task, or even some combination thereof.

In order to be efficient with resources, machines in the grid need to be flexible; logical partitions of and among grid hosts should configurable to handle the multitude of various requests. This flexibility, however, means that the grid configuration is constantly in flux, which in turn, can cause the runtime performance of requests to vary. That is, the same request may require more or less resources to complete depending on the state of the grid when a customer submits the request. Unfortunately, this runtime performance variance can create problems with “pay for use” methodologies; because customers are charged for their use of grid resources, the cost for a particular job will vary depending on the state of the grid when the customer submits that job. This phenomenon can lead to customer confusion and dissatisfaction because their charges are based, in part, on factors outside their control. Put more simply, most customers expect similar prices for accomplishing similar tasks.

Without a way to provide more uniform pricing for use of grid resources, the promise of utility computing may never be fully achieved.

### SUMMARY

Embodiments of the present invention provide a method, system, and computer program product that provide for more uniform pricing of utility computing resources, such as a computing grid. One aspect of the present invention is a method of calculating costs in a utility computing environment comprising receiving a request to process a work unit from a requestor, generating at least one performance metric associated with the work unit, and debiting the requestor for processing the work unit based at least in part on the performance metric. The performance metric in this embodiment is related to an amount of resources required to process the work unit under known, predetermined conditions.

### BRIEF DESCRIPTION OF THE DRAWINGS

FIG. 1 illustrates one embodiment of a grid computing environment.

FIG. 2 illustrates a method of collecting real-time grid usage information by a grid controller.

FIG. 3 illustrates one method of computing pricing for a work unit.

FIG. 4 illustrates the operation of another grid controller embodiment.

FIG. 5A illustrates one embodiment of a pricing configuration table.

FIG. 5B illustrates one embodiment of a resource used table.

FIG. 5C illustrates one embodiment of a grid configuration table.

FIG. 6 illustrates one method of adjusting the operation of the grid in response to the performance metrics.

FIG. 7 illustrates a computer system suitable for use as a grid host, a grid controller, a grid client, or a stand alone computer.

### DETAILED DESCRIPTION

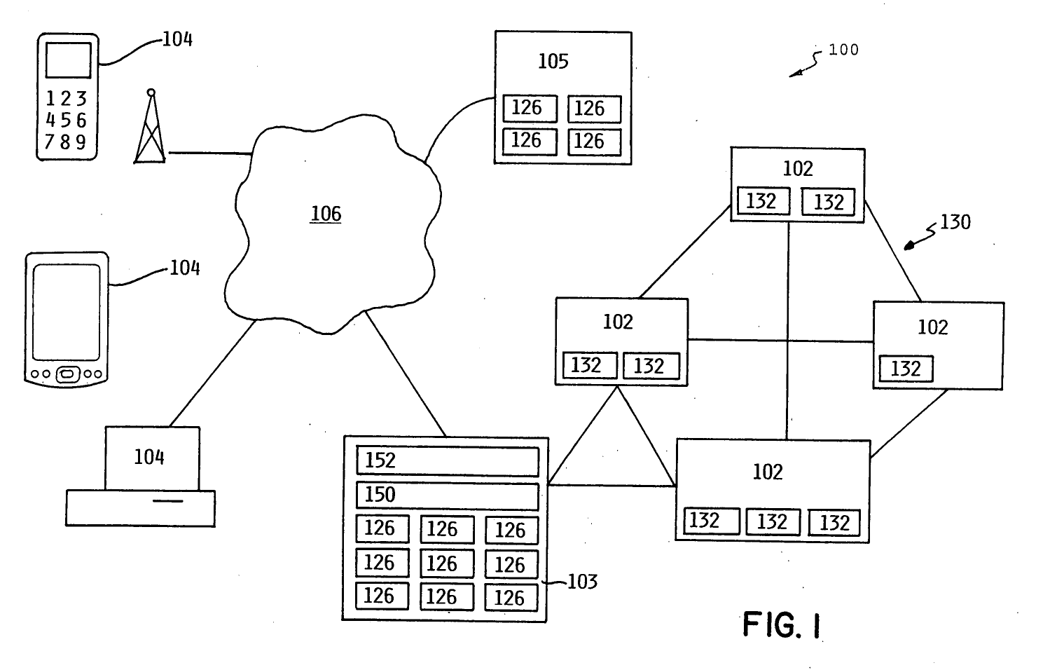

FIG. 1 illustrates a grid computing environment 100 embodiment comprising a plurality of grid hosts 102, each of which provides one or more grid resources 132 to a computing grid 130; a grid controller 103 that controls and facilitates access to the grid resources 132; a plurality of grid clients 104 that that send work units to the grid controller 103; and a benchmarking system 105. The grid controller 103 and the benchmarking system 105 in this embodiment both include a plurality of performance counters 126 that monitor the usage and performance of grid resources 132. The grid controller 103 further includes database 150 containing performance information about work units currently being processed by the grid 130 and a pricing schedule configuration file 152. The grid hosts 102, the grid clients 104, the grid controller 103, and the benchmarking system 105 are all communicatively linked together one another by one or more communications networks 106.

In operation, the present invention provides a mechanism to reduce or even remove payment irregularities between similar workloads submitted to the grid 130. Some embodiments provide this mechanism by monitoring performance characteristics of the grid 130 in real time and then adjusting measured usage in order to adjust for (e.g., subtract out) the affects of other workloads and/or the grid's configuration. Suitable performance characteristics include, without limitation: input/output (“I/O”) counts, both logical and physical; and CPU profiling information, such as CPU cycles per instruction (“CPI”), instructions executed, and/or and counts of how many times the work unit invokes key methods, procedures, and/or programs.

Other embodiments reduce or remove payment irregularities by creating a baseline for a particular work unit, and then recognizing when similar work units are later submitted to the grid 130. In these embodiments, the grid controller 103 establishes a baseline for each of a plurality of different types of work units by processing a sample work request on the benchmarking system 105 and/or on one of the grid host 102 under known conditions. While the benchmarking system 105 and/or the grid host 102 processes the sample work unit, the grid controller 103 collects the performance characteristics and stores the information in the database 150. The grid controller 103 can use the benchmark performance data to identify similar workloads in the future and then charge the customer based on the baseline performance characteristics. In some cases, the grid controller 103 may require multiple invocations of the benchmark workload to get an accurate representation of its required grid resources.

In either embodiment, the actual amount charged may be based on a variety of pricing criteria. Suitable pricing criteria include, without limitation, time-based criteria, request-type or class criteria, priority criteria, volume discount plans, historical information, system user identification criteria, and combinations thereof. These pricing criteria are embodied in the pricing schedule 152, which the grid controller 103 accesses to calculate the cost for a request. In some embodiments, this pricing schedule may be based on the exchange of money for computing services. In others, the pricing schedule 152 may be based on in-kind exchanges, such as trading computing services for advertisements. The grid controller 103 in some embodiments may also use the performance metrics to calculate an estimated cost for the workload before beginning actual processing.

Those skilled in the art will appreciate that many work unit requests can be serviced using a variety of execution plans. Typically, these plans use grid resources 132 in different proportions. One of these plans may be optimal from the requestor's perspective (i.e., results in the lowest cost), another may be optimal from the grid provider's perspective (i.e., maximizes total return from the grid 130). Accordingly, some embodiments of the present invention allow the grid provider to adjust execution plans of some work units to avoid bottlenecks (thereby improving the return from the grid 130) without penalizing requesting the requestor 104 for that decision. That is, the requesting client 104 will normally choose the least expensive execution plan (using schedule 152) that accomplishes its goals. This execution plan, however, may not be optimal from the grid owner's perspective because the customer's execution plan will contend with other work units for certain resources. Accordingly, some embodiments of the present invention can alter the execution plan to better utilize grid resources, but charge the requesting client 104 based on their preferred/selected execution plan. Thus, for example, if a grid 130 has the following charge schedule 152:

TABLE 1

| Resource | Cost/unit |
|---|---|
| Dedicated CPU | $0.10 |
| Shared CPU | $0.05 |
| I/O | $0.50 |
| Storage | $0.50 |

The requesting client 104 may develop an execution plan for a work unit that requires three dedicated CPU units and one I/O unit. If the grid controller 103 detects that the grid 130 is temporarily short on dedicated CPU resources, the grid controller 103 may develop a new execution plan that uses two dedicated CPU units and two I/O units, and then charge the customer $0.80 (i.e., for three dedicated CPU units and one I/O unit). In this way, the grid provider gains the advantage of the alternate execution plan without having to risk aggravating the requesting client 104, and the requesting client gains the advantage of predictable pricing.

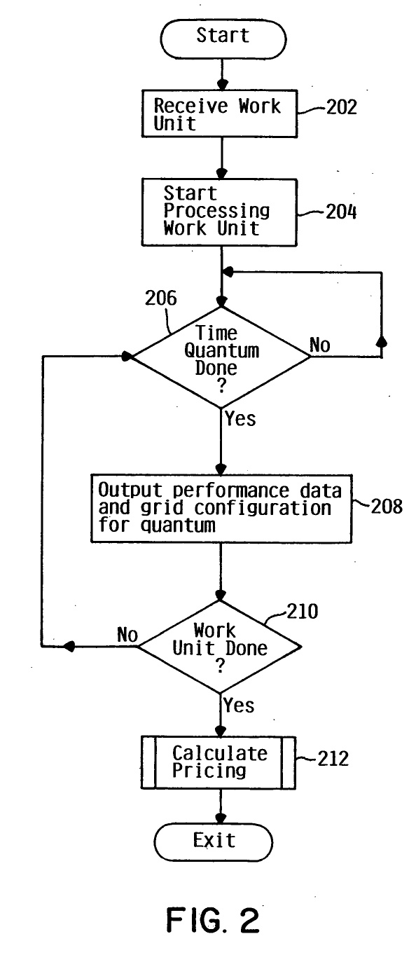

FIG. 2 illustrates the basic operation of one embodiment of the grid controller 103 in more detail, particularly one method of collecting real-time grid usage information. At block 202, the grid controller 103 receives a request for grid services (i.e., a work unit) from one of the grid clients 104 and assigns one or more performance counters 126 to that work unit. Next, the grid controller 103 instructs the grid 130 to process the work unit at block 204 and then waits until a predetermined quantum of time has passed (at block 206). After the time quantum has passed, the grid controller 103 records (at block 208) the values of the performance counters 126, the configuration for each grid host 102 providing resources 132 used to complete that work unit, and the grid's 130 overall configuration in the database 150. If the work unit requires additional grid resources 132 to complete (block 210), the grid controller 103 returns to block 206 to measure and record performance metrics for additional time quanta; otherwise the grid controller computes a price for the consumed grid resources 132 and debits the requesting client's 104 account at block 212, and then exits.

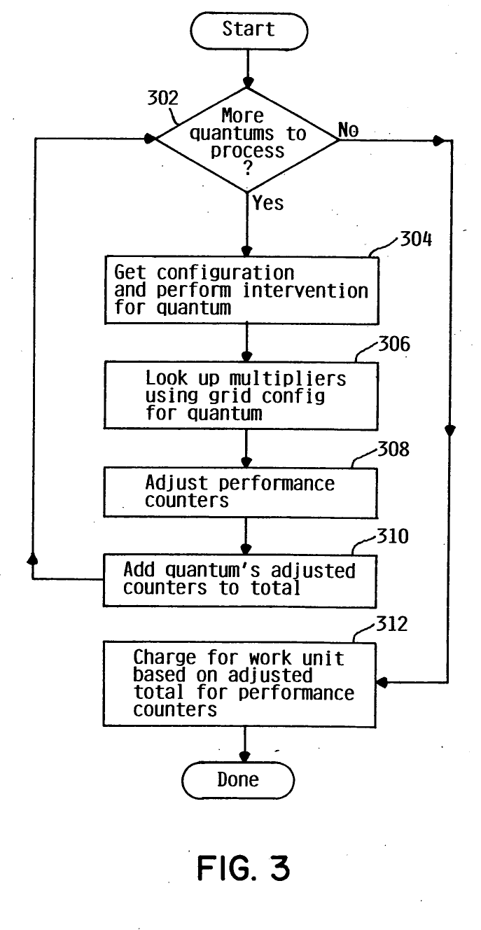

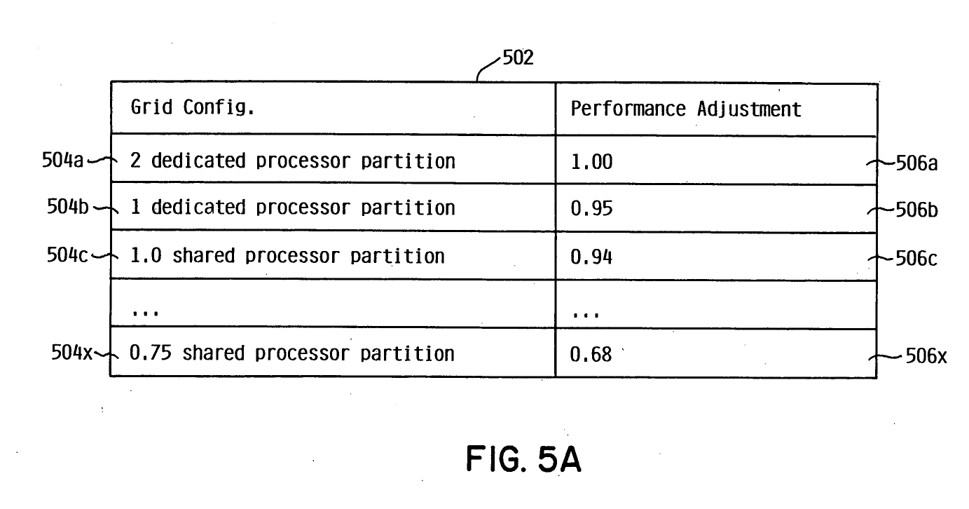

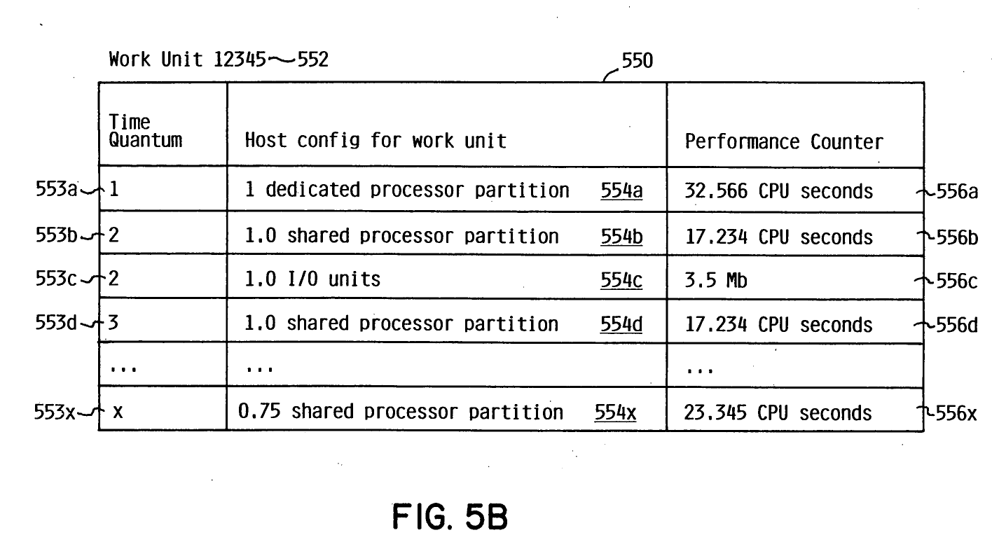

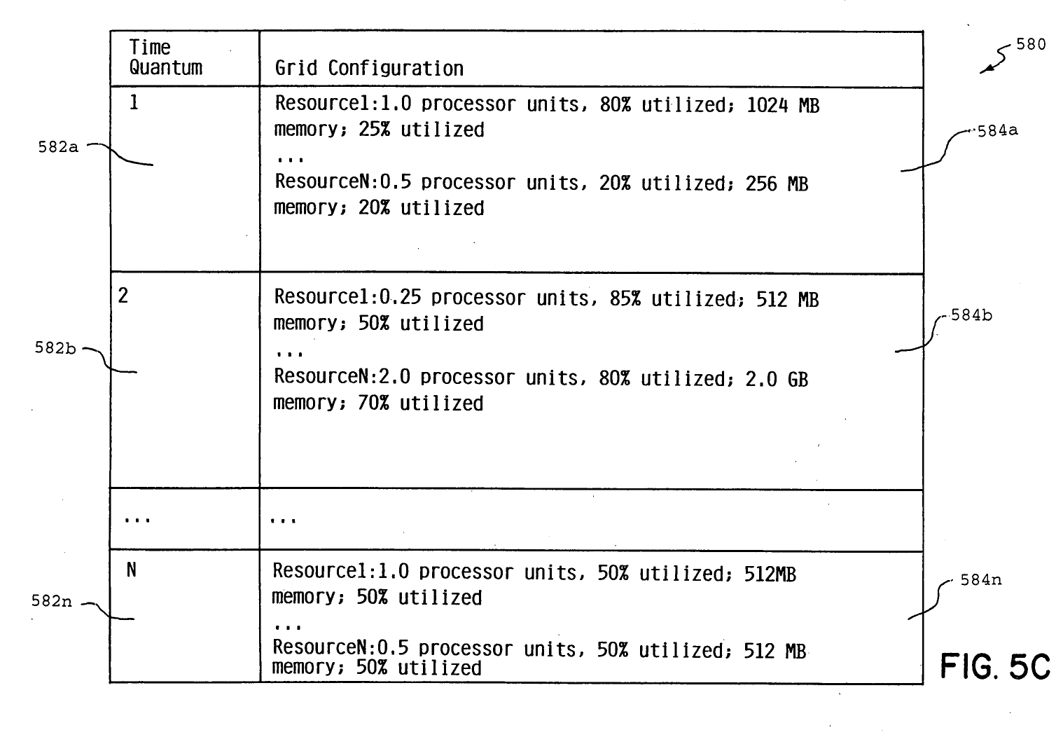

FIG. 3 illustrates one method of computing pricing for a work unit. At blocks 302-304, the grid controller 103 requests the performance counters and grid configuration associated with the first time quanta from the information's storage location. As will be discussed in more detail with reference to FIG. 5, the grid controller 103 uses this information at block 306 to lookup predetermined adjustment factors to account for the grid hosts' configuration(s) and overall load. These factors may be empirically determined or derived a priori. Next, at block 308, the grid controller 103 adjusts the performance metrics using the adjustment factors and applies the adjusted metrics to the requesting client's 104 account. If the grid 130 requires additional time quanta to finish the work unit, the grid controller repeats to blocks 306-310, otherwise the grid controller 103 debits the account of the requesting client 104 for the work unit at block 312 based on the sum of the adjusted performance metrics.

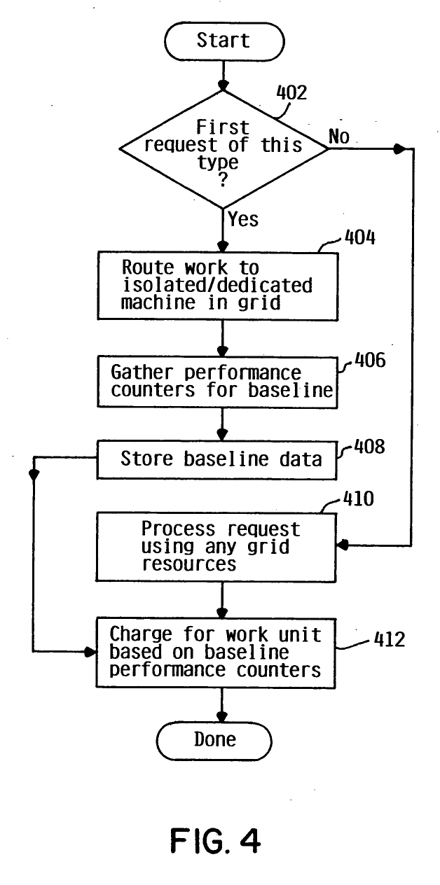

FIG. 4 illustrates the operation of a second embodiment of the grid controller 103. At block 402, the grid controller 103 determines if the grid 130 has previously received similar work units. If so, the grid controller 103 routes the work unit to the benchmarking system 105 at block 404. Alternatively, the grid controller 103 waits until the grid 130 has low amount of usage and then sends the work unit to the grid 130. The benchmarking system 105 and/or grid 130 then performs the requested work and generates performance metrics at block 406 and stores these performance metrics in the database 150 at block 408.

If this is not the first time the grid 130 has received this type of work unit, the grid sends the work unit to the grid 130 for processing at block 410. The grid controller 103 then debits the account of the requesting client 104 at block 412. If the work unit was performed by the benchmarking system 105 (or the grid 130 under known conditions), the charged amount is based on the measured performance metrics. If the work was performed by the grid 130 under normal conditions, the charged amount is based on the baseline performance counters, regardless of how many grid resources 132 the work unit actually required.

One method that could be used to identify similar work units is for each grid client 104 to explicitly categorize the work when it is submitted to the grid controller 103. If this method is not possible and/or not trusted, the grid controller 103 can categorize work units autonomically by looking at certain characteristics of the executing job. Thus, for example, the grid controller 103 can monitor the invocation of certain methods, I/O counts, processor usage, etc. for some or all of the workload in order to identify a similar baseline and then use the baseline to extrapolate the actual charges. All the counts would not have to match exactly, but several of the methods being monitored should come close matching and/or have similar ratios as in the baselines. Similarly, a match could be determined if not all the above characteristics were deemed to match, but if a subset or most did. Depending upon the job type being submitted, other characteristics might be used to determine a match, such as the number of SQL calls or number of records retrieved from a database and a number of socket and/or file open and closes.

FIGS. 5A-5C illustrate one embodiment of a database 150 suitable for use with one or both of the embodiments described in FIGS. 1-4. More specifically, FIG. 5A illustrates one embodiment 502 of the pricing schedule configuration file 152. This embodiment 502 comprises a plurality of grid resources state fields 504a-504x and performance adjustment fields 506a-506x. The grid resource state fields 504 contain information about various grid resources 132 at common load states. The performance adjustment fields 506 contain information that the grid controller 103 uses to adjust the amount it will debit the requesting client's account for use of that grid resource 132. One suitable type of adjustment information is a multiplier that the grid controller 103 can use to reduce or increase the performance counters 126 described with reference to FIGS. 1-4. Those skilled in the art will appreciate that the amounts, adjustments, and resources in this embodiment are only exemplary. The actual charged amounts, adjustments, and resources will generally be documented in a service agreement between the grid provider and the requesting clients 104.

FIG. 5B illustrates one embodiment of a resource-use table 550 containing information about each active work unit in the grid 130. Accordingly, each table 550 comprises a work unit identifier 552, a plurality a time quantum fields 553a-553x, a plurality of host configuration fields 554a-554x, and a plurality of performance counter fields 556a-556x. The time quantum fields 553 contain information about the number of time quanta required to process the work unit. The grid configuration fields 554 contain information that identifies what grid resource(s) 132 were used by the grid 130 for that work unit 552 during each time quantum 553. The performance counter fields 556 contain information about the amount of the grid resources that were actually required to process that work unit (e.g., the performance counter(s) for the resource(s)). Those skilled in the art will appreciate that because some work units may require several grid resources, a particular time quantum 553 may have multiple entries in the table 550.

FIG. 5C illustrates one embodiment of a grid configuration table 580 containing information about the configuration of the grid 130 at each time quantum. This embodiment comprises a plurality of time quantum fields 582a-582n and a plurality of grid configuration fields 584a-584n. The time quantum fields 582 contain information that identifies any time quanta in which an unbilled work unit consumed grid resources 132. The grid configuration fields 584 contain information describing the overall configuration of and load on the grid 130 during the associated time quantum.

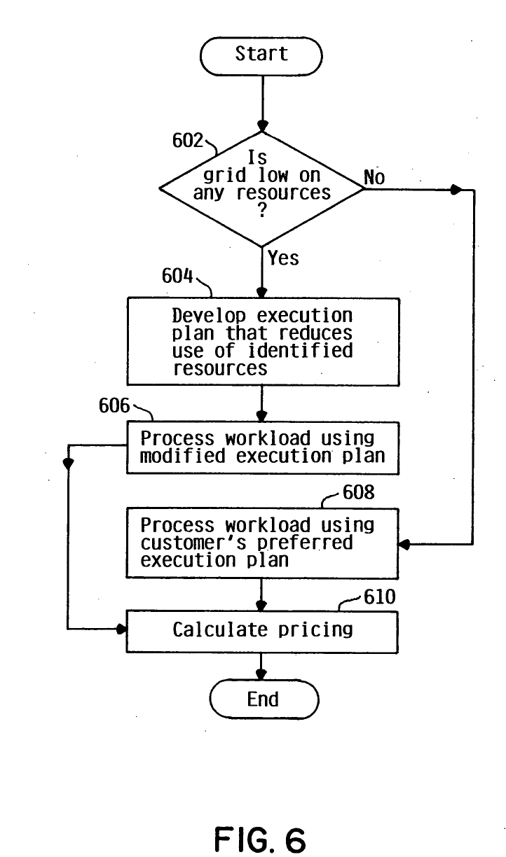

FIG. 6 illustrates one method of adjusting the operation of the grid 130 in response to the performance characteristics obtained during the blocks described with reference to FIGS. 1-5. In block 602, the grid controller 103 determines if the grid 130 is low on any particular resource 132. In some embodiments, this may be accomplished by polling all of the grid hosts 102. In others embodiments, this may be accomplished by estimating the load on the grid 130 using the benchmarks and the list of active jobs. If the grid controller 103 determines that the grid 130 is running low on a particular resource type, the grid controller 103 alters the execution plans of any new work units (at block 604) to use optimizations that reduce the load on the scarce resource and instructs the grid 130 to process the workload according to the modified execution plan (at block 606). Thus, for example, if the grid 130 is short on CPU resources, the grid controller 103 could use optimizations that favor increased I/O over CPU usage. If grid controller determined at block 602 that the grid 130 is not short on any resources, the grid controller 103 will proceed using the customer's preferred execution plan at block 608. In either case, the grid controller 103 debits the customer's account at block 610 according to the customer's preferred execution plan.

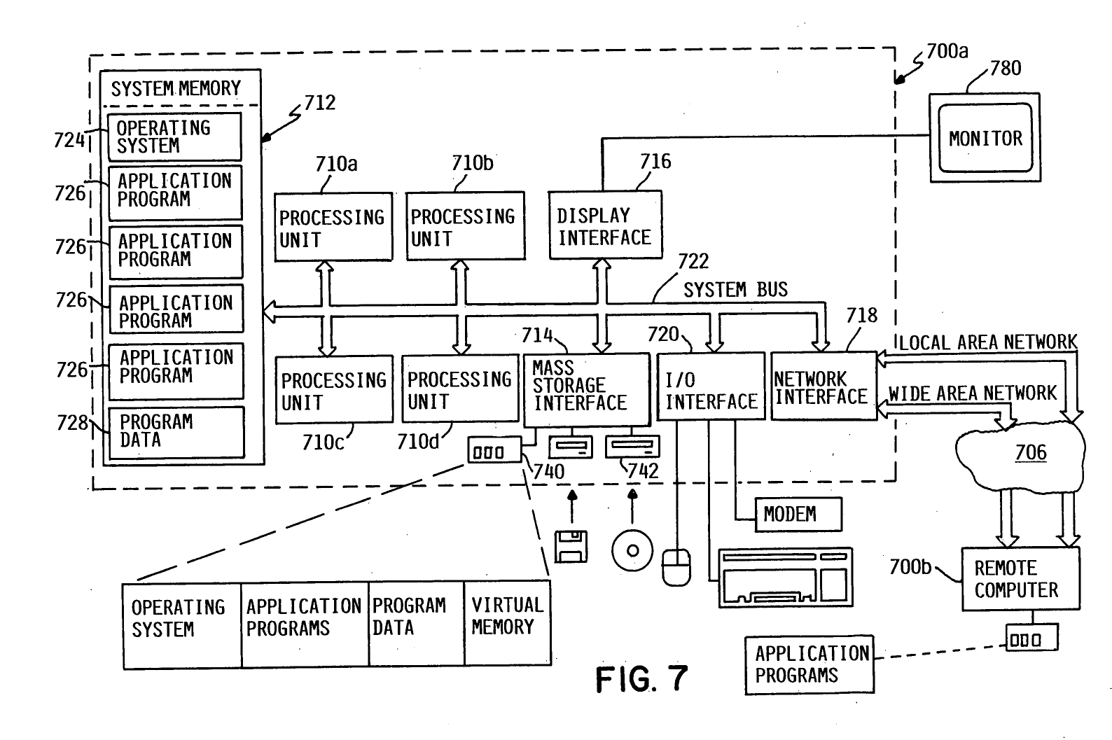

FIG. 7 illustrates a computer system 700 suitable for use as a grid host 102, a grid controller 103, a grid client 104, and/or the stand alone benchmarking computer 105. It should be understood that this figure is only intended to depict the representative major components of the computer system 700 and that individual components may have greater complexity that represented in FIG. 7. In some embodiments, the computing systems 700 implemented as a personal computer, server computer, portable computer, laptop or notebook computer, PDA (Personal Digital Assistant), tablet computer, pocket computer, telephone, pager, automobile, teleconferencing system, appliance, or any other appropriate type of electronic device. Moreover, components other than or in addition to those shown in FIG. 7 may be present, and that the number, type, and configuration of such components may vary.

The computing system 700 in FIG. 7 comprises a plurality of central processing units 710a-710d (herein generically referred to as a processor 710 or a CPU 710) connected to a main memory unit 712, a mass storage interface 714, a terminal/display interface 716, a network interface 718, and an input/output (“I/O”) interface 720 by a system bus 722. These resources may be made available to the grid 130 (see FIG. 1), or may be reserved for other tasks. The mass storage interfaces 714, in turn, connect the system bus 722 to one or more mass storage devices, such as a direct access storage device 740 or a readable/writable optical disk drive 742. The network interfaces 718 allow the computer system 700 to communicate with other computing systems 700 over the communications medium 706. The main memory unit 712 in this embodiment also comprises an operating system 724, a plurality of application programs 726 (such as grid controller 103), and some program data 728 (such as database 150).

This computing system 700 embodiment is a general-purpose computing device. Accordingly, the CPU's 710 may be any device capable of executing program instructions stored in the main memory 712 and may themselves be constructed from one or more microprocessors and/or integrated circuits. In this embodiment, the computing system 700 contains multiple processors and/or processing cores, as is typical of larger, more capable computer systems; however, in other embodiments the computing systems 700 may comprise a single processor system and/or a single processor designed to emulate a multiprocessor system.

When the computing system 700 starts up, the associated processor(s) 710 initially execute the program instructions that make up the operating system 724, which manages the physical and logical resources of the computer system 700. These resources include the main memory 712, the mass storage interface 714, the terminal/display interface 716, the network interface 718, and the system bus 722. As with the processor(s) 710, some computer system 700 embodiments may utilize multiple system interfaces 714, 716, 718, 720, and busses 722, which in turn, may each include their own separate, fully programmed microprocessors.

The system bus 722 may be any device that facilitates communication between and among the processors 710; the main memory 712; and the interfaces 714, 716, 718, 720. Moreover, although the system bus 722 in this embodiment is a relatively simple, single bus structure that provides a direct communication path among the system bus 722, other bus structures are within the scope of the present invention, including without limitation, point-to-point links in hierarchical, star or web configurations, multiple hierarchical buses, parallel and redundant paths, etc.

The main memory 712 and the mass storage devices 740 work cooperatively to store the operating system 724, the application programs 726, and the program data 728. In this embodiment, the main memory 712 is a random-access semiconductor device capable of storing data and programs. Although FIG. 7 conceptually depicts this device as a single monolithic entity, the main memory 712 in some embodiments may be a more complex arrangement, such as a hierarchy of caches and other memory devices. For example, the main memory 712 may exist in multiple levels of caches, and these caches may be further divided by function, so that one cache holds instructions while another holds non-instruction data, which is used by the processor or processors. Memory may be further distributed and associated with different CPUs 710 or sets of CPUs 710, as is known in any of various so-called non-uniform memory access (NUMA) computer architectures. Moreover, some embodiments may utilize virtual addressing mechanisms that allow the computing systems 700 to behave as if it has access to a large, single storage entity instead of access to multiple, smaller storage entities such as the main memory 712 and the mass storage device 740.

Although the operating system 724, the application programs 726, and the program data 728 are illustrated as being contained within the main memory 712, some or all of them may be physically located on different computer systems and may be accessed remotely, e.g., via the network 106, in some embodiments. Thus, while the operating system 724, the application programs 726, and the program data 728 are illustrated as being contained within the main memory 712, these elements are not necessarily all completely contained in the same physical device at the same time, and may even reside in the virtual memory of other computer systems 700, such as another one of the grid hosts 102.

The system interface units 714, 716, 718, 720 support communication with a variety of storage and I/O devices. The mass storage interface unit 714 supports the attachment of one or more mass storage devices 740, which are typically rotating magnetic disk drive storage devices, although they could alternatively be other devices, including arrays of disk drives configured to appear as a single large storage device to a host and/or archival storage media, such as hard disk drives, tape (e.g., mini-DV), writeable compact disks (e.g., CD-R and CD-RW), digital versatile disks (e.g., DVD, DVD-R, DVD+R, DVD+RW, DVD-RAM), holography storage systems, blue laser disks, IBM Millipede devices and the like.

The terminal/display interface 716 is used to directly connect one or more display units 780 to the computer system 700. These display units 780 may be non intelligent (i.e., dumb) terminals, such as a cathode ray tube, or may themselves be fully programmable workstations used to allow IT administrators and users to communicate with the computing system 700. Note, however, that while the display interface 716 is provided to support communication with one or more displays 780, the computer systems 700 does not necessarily require a display 780 because all needed interaction with users and other processes may occur via network interface 718.

The network 706 may be any suitable network or combination of networks and may support any appropriate protocol suitable for communication of data and/or code to/from multiple computing systems 700. Accordingly, the network interfaces 718 can be any device that facilitates such communication, regardless of whether the network connection is made using present day analog and/or digital techniques or via some networking mechanism of the future. Suitable communication media 706 include, but are not limited to, networks implemented using one or more of the “Infiniband” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra Wide Band (“UWB”) technology, such as that described in FCC 02-48; or the like. Those skilled in the art will appreciate that many different network and transport protocols can be used to implement the communication medium 106. The Transmission Control Protocol/Internet Protocol (“TCP/IP”) suite contains suitable network and transport protocols.

Some of the computing systems 700 may be interconnected in a grid arrangement. The grid can be implemented using any suitable protocol for registering components and communicating information between those components. Suitable standards include the Globus Alliance's Globus Toolkit and the Global Grid Forum's Project's Open Grid Services Architecture (OGSA) and Open Grid Services Infrastructure (OSGI), which are herein incorporated by reference in their entirety. These standards are desirable because they provide a platform upon which grid services can be built.

One exemplary computing system 700, particularly suitable for use as a grid host 102, grid controller 103, and benchmarking workstation 105, is an eServer iSeries computer running the i5/OS multitasking operating system, both of which are produced by International Business Machines Corporation of Armonk, N.Y. Another exemplary computing system 700, particularly suitable for the grid client 104, is an IBM ThinkPad computer running the Linux or Windows operating systems. However, those skilled in the art will appreciate that the methods, systems, and apparatuses of the present invention apply equally to any computing system 700 and operating system combination, regardless of whether one or both of the computer systems 700 are complicated multi user computing apparatuses, a single workstations, lap-top computers, mobile telephones, personal digital assistants (“PDAs”), video game systems, or the like.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of signal bearing media used to actually carry out the distribution. Examples of suitable signal bearing media include, but are not limited to: (i) information permanently stored on non writable storage media (e.g., read only memory devices within a computer such as CD ROM disks readable by a CD ROM drive); (ii) alterable information stored on writable storage media (e.g., floppy disks within a diskette drive, a CD R disk, a CD RW disk, or hard disk drive); or (iii) information conveyed to a computer by a communications medium, such as through a computer or telephone network, including wireless communications, and specifically includes information downloaded from the Internet and other networks. Such signal bearing media, when carrying computer readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software and web services that implement, some or all of the methods described herein. Aspects of these embodiments may also include analyzing the client's operations, creating recommendations responsive to the analysis, generating software to implement portions of the recommendations, integrating the software into existing processes and infrastructure, metering use of the systems, allocating expenses to users of the systems, and billing for use of the systems. This service engagement may be directed at providing both the grid services and the grid controller services, may be limited to only providing grid controller services, or some combination thereof. Accordingly, these embodiments may further comprise receiving billing information from other entities and associating that billing information with users of the computing grid 130.

Moreover, although the present invention has been generally described with reference to a computing grid 130 and grid resources 132, embodiments may be used in conjunction with any utility computing system. Thus, for example, some embodiments may be used in conjunction with the temporary capacity on demand systems and methods described in U.S. patent application Ser. No. 10/406,164, entitled “Method to Ensure Temporary Capacity on Demand Contract Compliance;” Ser. No. 10/424,636, entitled “Method to Process Temporary Capacity on Demand Unreturned Resources;” Ser. No. 10/406,652, entitled “Method to Provide Temporary Capacity on Demand;” and Ser. No. 10/616,676, entitled “Method to Provide Metered Capacity on Demand;” which are all herein incorporated by reference in their entirely.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

We claim:

1. A computer-implemented method of calculating costs in a utility computing environment, comprising:
receiving a request to process a work unit from a requester;
generating at least one performance metric associated with the work unit, wherein the performance metric is related to an amount of resources required to process the work unit under known conditions; and
debiting the requestor for processing the work unit based at least in part on the performance metric.

2. The method of claim 1, wherein the performance metric comprises a baseline generated on a benchmarking system.

3. The method of claim 1, wherein the performance metric comprises a baseline generated on a grid host under known conditions.

4. The method of claim 1, wherein generating the performance metric comprises:
metering use of a grid resource; and
adjusting the metered use based on a real-time host configuration.

5. The method of claim 4, further comprising adjusting the metered use based on a real time host load.

6. The method of claim 1, wherein generating the performance metric comprises:
metering use of a grid resource; and
adjusting the metered use based on a real-time grid configuration.

7. The method of claim 6, further comprising adjusting the metered use based on a real-time grid load.

8. The method of claim 1, further comprising:
receiving an original execution plan for the work unit;
generating an alternate execution plan for the work unit; and
processing the work unit using the alternate execution plan, wherein the performance metric is related to an amount of resources required to process the work unit using the original execution plan.

9. A grid controller for a computing grid, the computing grid having a plurality of grid resources, the controller comprising:
a job scheduler that receives requests to process work units and sends the work unit to the grid;
a performance analyzer that generates at least one performance metric associated with the work unit, wherein the performance metric is related to an amount of resources required to process the work unit under known conditions; and
a billing module communicatively coupled to the job scheduler and the performance analyzer, the billing module generating a charge for the work unit based at least in part on the performance metric.

10. The grid controller of claim 9, wherein the grid comprises a computing system logically partitioned into a plurality of grid resources.

11. The grid controller of claim 9, wherein the performance metric comprises a baseline generated on a benchmarking system.

12. The grid controller of claim 9, wherein the performance metric comprises a baseline generated on a grid host under known conditions.

13. The grid controller of claim 9, wherein generating the performance metric comprises:
metering use of a grid resource; and
adjusting the metered use based on a real-time host configuration

14. The grid controller of claim 9, wherein generating the performance metric comprises:
metering use of a grid resource; and
adjusting the metered use based on a real-time grid configuration.

15. The grid controller of claim 14, further comprising adjusting the metered use based on a real-time grid load.

16. The grid controller of 9, further comprising an optimizer that receives an original execution plan for the work unit and generates an alternate execution plan based on a real time grid configuration, wherein the performance metric is related to an amount of resources required to process the work unit using the original execution plan.

17. A computer program product, comprising:
(a) a program configured to perform a method of calculating costs in a utility computing environment, the method comprising:
receiving a request to process a work unit from a requester;
generating at least one performance metric associated with the work unit, wherein the performance metric is related to an amount of resources required to process the work unit under predetermined conditions; and
billing the requester for processing the work unit based at least in part on the performance metric;
(b) a signal bearing media bearing the program.

18. The computer program product of claim 17, wherein the signal bearing media is chosen from the group consisting of: information permanently stored on non-writable storage media; alterable information stored on writable storage media; and information conveyed to a computer by a communications medium.

19. A method for deploying computing infrastructure, comprising integrating computer readable code into a computing system, wherein the code in combination with the computing system is capable of performing a method of calculating costs in a utility computing environment comprising:
receiving a request to process a work unit from a requester;
generating at least one performance metric associated with the work unit, wherein the performance metric is related to an amount of resources required to process the work unit under predetermined conditions; and
billing the requestor for processing the work unit based at least in part on the performance metric.

20. The method of claim 19, further comprising:
analyzing the computing system;
creating recommendations responsive to the analysis; and
generating computer readable code to implement portions of the recommendations.

21. The method of claim 19, further comprising:
interconnecting a plurality of computing systems into a computing grid; and
forwarding the work unit to the computing grid.

22. The method of claim 19, further comprising:
associating the request for a first user;
receiving a charge associated with the request from a grid service provider; and
associating the charge with the first user.

23. The method of claim 19, further comprising:
associating the request for a first user;
metering use of the web services; and
charging the first user a fee based at least in part on the metered use.
